(19) United States
(12) Patent Application Publication
(10) Pub. No.: US 2010/0109969 A1
(43) Pub. Date: May 6, 2010

(54) Mobile, Temporary Cellular Communication Station

(76) Inventors: Allen C. Martindale, Winchester, CA (US); George Von Borstel, Vista, CA (US)

Correspondence Address: CHARMASSON, BUCHACA & LEACH, LLP, 2635 Camino Del Rio South, Suite 102, SAN DIEGO, CA, 92108, US

(21) Appl. No.: 12/263,211

(22) Filed: Oct. 31, 2008

(51) Int. Cl. H01Q 1/08

(52) U.S. Cl. 343/880

(57) ABSTRACT

A mobile, temporary cellular communication station is mounted on a handbarrow or dolly that can be conveniently carried on the bed of a pickup truck or in the trunk of a car, then rapidly deployed and put into operation on any site by one or more technicians. The station includes a collapsible antenna mast and a connector panel that can accommodate a power cord and the signal cable between an electronic module and a pair omni-directional antennas.

### FIELD OF THE INVENTION

The instant invention relates to mobile electromagnetic radiation devices and more particularly to temporary cellular communication stations.

### BACKGROUND

It is often necessary to enhance or expand a cellular telephone communication network by setting up a temporary relaying station to service a particular geographical area and thereby provide coverage to a new geographical area, and/or accommodate a greater number of users in a given area. This is usually accomplished by deploying a truck or trailer-housed complete cell or micro-cell installation or by mounting a micro-cell installation against a wall or other permanent structure. Special events such as sport competitions, county fairs, conventions, occasional gatherings, and emergency deployments such as after natural disasters call for such an installation to be used over a few days, weeks, months or years or, at times, only a few hours.

The instant invention results from an attempt to devise a more rapid and less costly means to provide a temporary micro-cell capability at anytime or place.

### SUMMARY

A portable cellular communication relaying stations is packaged in a compact electronic module mounted on the bed of a handbarrow that can be conveniently transported to a site and wheeled to the most effective spot. A collapsible mast is mounted on the handbarrow. The mast can accept a pair of omnidirectional antennas detachably secured to the end of a cross-member on top of the mast.

In an exemplary embodiment of the invention a portable electromagnetic radiation (EMR) installation comprises: a handbarrow; an electronic module mounted on said handbarrow; at least one antenna element; a collapsible mast mounted on said handbarrow and having means for removably supporting said antenna.

In some embodiments the handbarrow comprises: a flat bed having a top face supporting said module and a bottom face; at least one roller at a first end portion of said bed; a first handle projecting from an opposite end portion of said bed, said handle and said roller being shaped, oriented and dimensioned to support said bed in a position substantially parallel to a surface upon which said handle and roller are resting; and, a foot projecting from sais first end portion of said bottom face, said foot and said roller being shaped, oriented and dimensioned to place said bed in a position substantially perpendicular to a surface upon which said foot and roller are resting.

In some embodiments the means for supporting comprise a socket secured to said bed.

In some embodiments the installation further comprises a connector panel secured to said bed.

In some embodiments the mast comprises a beam and a cross-arm secured to an upper portion of said beam.

In some embodiments the foot comprises a U-shaped member doubling as a second handle.

In some embodiments the handbarrow comprises a tubular frame.

In some embodiments the installation consists of a temporary cellular communication station having a power of at least 5 Watts.

In some embodiments the installation has total weight is less than 82 kilogram (180 lbs.) In some embodiments the dimensions of the installation in its collapsed configuration do not exceed 135 centimeters (53 inches) in height, 69 centimeters (27 inches) in width and 43 centimeters (17 inches) in depth.

### BRIEF DESCRIPTION OF THE DRAWINGS

FIG. 1 is a front view of a cellular communication station with a supporting dolly shown in the upright position;

FIG. 2 is a side view of a similar station with the supporting dolly in the horizontal position; and,

FIG. 3 is a back view of the station in the collapsed mode and ready for transportation.

### DESCRIPTION OF THE EXEMPLARY EMBODIMENTS

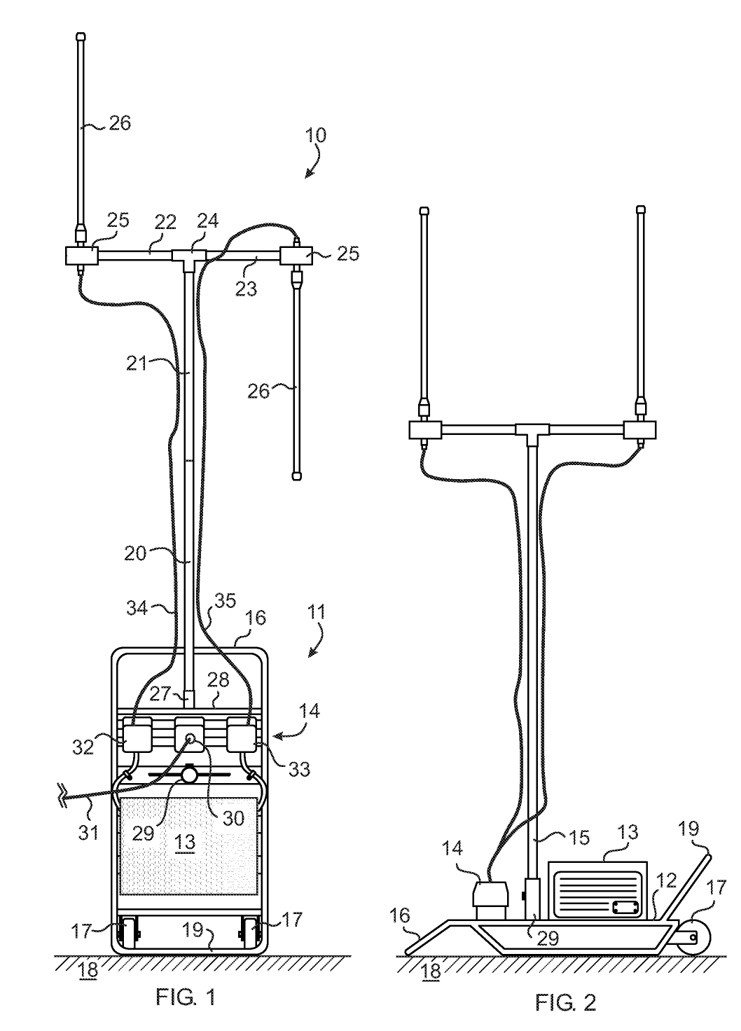

Referring now to the drawing, there is shown in FIG. 1 a cellular communication station 10 in operating condition. The station is mounted on a tubular framework in the shape of a handbarrow or dolly 11. As more specifically illustrated in FIG. 2, the dolly comprises a bed 12 having a top face supporting an electronic module 13, a connection panel 14 and antenna mast 15. A handle 16 projects obliquely from one longitudinal end of the bed bottom face. A pair of rollers 17 are mounted at the opposite longitudinal ends of the bed. The handle and the rollers are shaped and dimensioned to hold the bed 12 in a position substantially parallel to the ground surface 18 upon which the handle and the end rollers are resting in a first mode of operation.

In a second mode of operation illustrated in FIG. 1, the dolly rests on its rollers 17 and on a foot 19 which projects obliquely from the top surface of the bed at the opposite end from the handle 16 and in an opposite direction. The foot has a U-shape that allows it to act as a second handle that is particularly useful when lifting the station out of the trunk of car or the bed of a pickup. The foot 19 and the rollers 17 are shaped, oriented, and dimensioned to place the dolly in a substantially perpendicular position to the resting surface 18.

The antenna mast 15 comprises a beam made of two interconnecting sections 20, 21 and two cross-members 22, 23 secured to the top of the uppermost section 21 by a T-coupling 24. A crimping socket 25 at the outer end of each cross-member can accept the base of an omni-directional antenna 26. In the vertical mode of FIG. 1, the base of the mast is inserted into a socket 27 welded to a cross-tubular member 28 of the bed 12. In the horizontal mode of FIG. 2, the base of the mast is planted into a sheath 29 secured to the bottom face of the bed.

The connection panel 14 includes a power inlet 30 for connection to a power cord 31 and two multi-pin connectors sockets 32, 33 for connections to the antenna cables 34, 35.

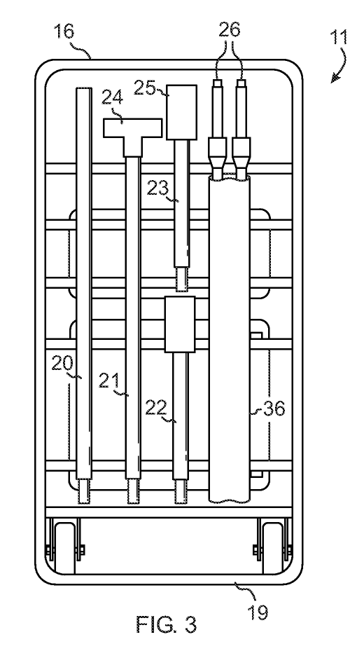

As illustrated in FIG. 3, the collapsed elements of the mast 20-25 and the antennas 26 can be conveniently stored against the bottom face of the bed by means of clips, fabric straps or other similar and equivalent fastening means, and the antennas 26 may be conveniently held in a sheath 36 also secured to the bed. The cables can likewise be coiled and fastened to the bed or within the protective housing of the electronic module 13.

The station can carrying microcell systems which deliver up to 40 Watts of power, and will have a nominal output power of at least 5 Watts. The dimensions of the entire station in its collapsed configuration illustrated in FIG. 3 does not exceed 135 centimeters (53 inches) in height, 69 centimeters (27 inches) in width and 43 centimeters (17 inches) in depth, the total weight of the station is less than 82 kilograms (180 lbs.). In this way the system can often be easily transported to a remote location and rapidly deployed and quickly put into operation if necessary by a single person.

The tubular framework arrangement allows the dolly to be readily adapted to secure a number of micro-cell devices of different shapes, sizes and mounting schemes available from various manufacturers

While the exemplary embodiments of the invention have been described, modifications can be made and other embodiments may be devised without departing from the spirit of the invention and the scope of the appended claims.

What is claimed is:

1. A portable EMR installation which comprises:
a handbarrow;
an electronic module mounted on said handbarrow;
at least one antenna element;
a collapsible mast mounted on said handbarrow and having means for removably supporting said antenna.

2. The installation of claim 1, wherein said handbarrow comprises:
a flat bed having a top face supporting said module and a bottom face;
at least one roller at a first end portion of said bed;
a first handle projecting from an opposite end portion of said bed, said handle and said roller being shaped, oriented and dimensioned to support said bed in a position substantially parallel to a surface upon which said handle and roller are resting;
a foot projecting from sais first end portion of said bottom face, said foot and said roller being shaped, oriented and dimensioned to place said bed in a position substantially perpendicular to a surface upon which said foot and roller are resting.

3. The installation of claim 2, wherein said means for supporting comprise a socket secured to said bed.

4. The installation of claim 1, which further comprises a connector panel secured to said bed.

5. The installation of claim 1, wherein said mast comprises a beam and a cross-arm secured to an upper portion of said beam.

6. The installation of claim 2, wherein said foot comprises a U-shaped member doubling as a second handle.

7. The installation of claim 2, wherein said handbarrow comprises a tubular frame.

8. The installation of claim 1, which consists of a temporary cellular communication station having a power of at least 5 Watts.

9. The installation of claim 8, which total weight is less than 82 kilogram (180 lbs.) 10. The installation of claim 8, which collapses into a module having dimensions not exceeding 135 centimeters (53 inches) in height, 69 centimeters (27 inches) in width and 43 centimeters (17 inches) in depth.
